(19) United States
(12) Patent Application Publication
(10) Pub. No.: US 2010/0285345 A1
(43) Pub. Date: Nov. 11, 2010

(54) PORTABLE ELECTRONIC DEVICE

(75) Inventors: MU-WEN YANG, Taipei (TW); CHIH-CHIANG CHANG, Taipei (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/634,792

(22) Filed: Dec. 10, 2009

(30) Foreign Application Priority Data
May 11, 2009 (CN) 200910302222.8

(51) Int. Cl. H01M 2/10

(52) U.S. Cl. 429/100

(57) ABSTRACT

A portable electronic device includes a housing, a battery cover and a cushion. The battery cover removably latches the housing. The cushion is disposed between the housing and the battery cover for elastically contacting a battery. When the battery cover is assembled in the housing, the cushion may decrease any impact forces on the battery. The cushion also may reduce the abrasions on the battery.

### BACKGROUND

1. Technical Field

The present disclosure generally relates to portable electronic devices and, particularly, to a portable electronic device providing effective protection of batteries therein.

2. Description of Related Art

Batteries are widely used in portable electronic devices, such as personal digital assistants (PDAs), mobile phones, and others. Conventional batteries are received in the electronic device, with battery covers connecting with the housings of the electronic devices and directly contacting the batteries, providing containment of the batteries. The battery covers must be opened when, for example, the batteries are damaged and/or exhausted and require replacement.

However, the conventional engagement between the battery cover, the battery, and the housing of the mobile phone can be too firm to afford easy detachment thereof. In opposing such engagement, damage to the battery cover and the housing is likely. Additionally, application of extraordinary force when the battery cover is removed can severly damage the battery.

Therefore, there is room for improvement within the art.

### BRIEF DESCRIPTION OF THE DRAWINGS

Many aspects of the portable electronic device can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views, in which:

FIG. 1 is an exploded, isometric view of a portable electronic device employing a cushion in accordance with an exemplary embodiment;

FIG. 2 is similar to FIG. 1, but viewed from another aspect;

FIG. 3 is a partially assembled view showing the cushion mounted in the battery cover of FIG. 1;

FIG. 4 is an assembly view of FIG. 1; and

FIG. 5 is a cross-section of the portable electronic device of FIG. 4 taken along V-V.

### DETAILED DESCRIPTION OF THE EMBODIMENTS

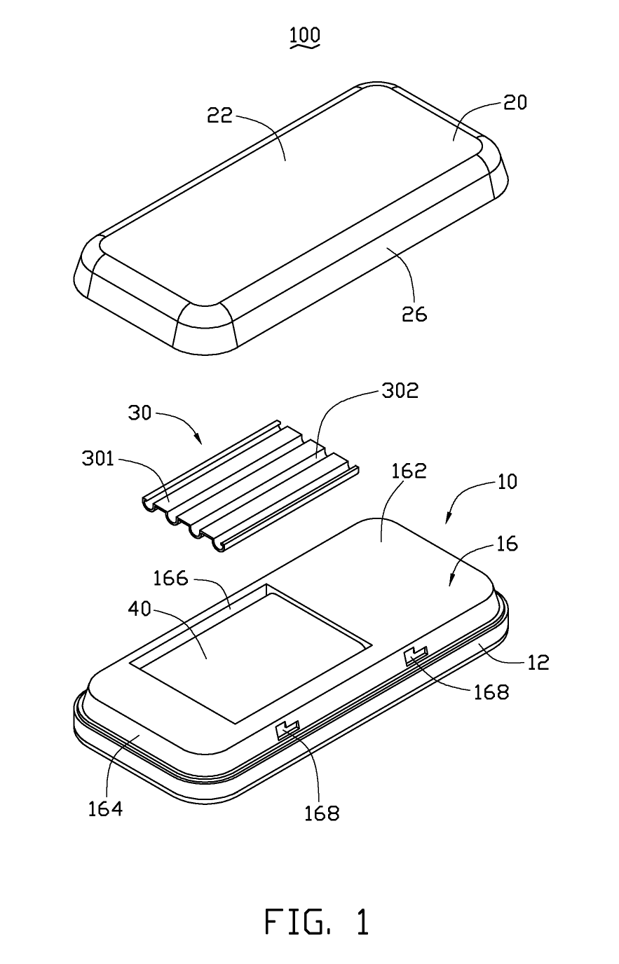

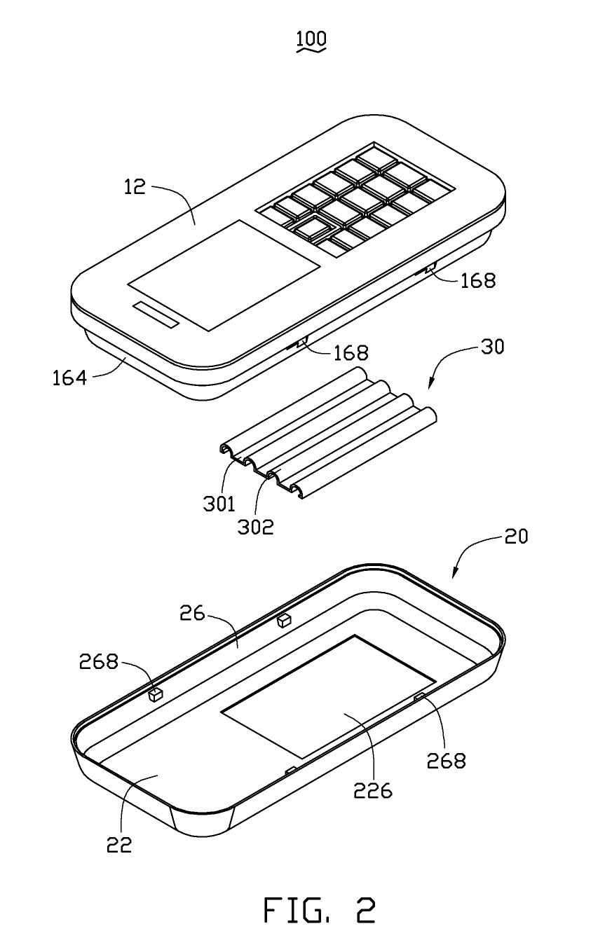

FIGS. 1 and 2 show a portable electronic device 100, such as a mobile phone, employing a battery cover. The mobile phone 100 is an exemplary application, for the purposes of describing details of the portable electronic device of an exemplary embodiment. The portable electronic device 100 includes a housing 10, a removable battery cover 20, a cushion 30 and a battery 40. The battery cover 20 is detachably attached to the housing 10.

The housing 10 includes a first side portion 12 and an opposite second side portion 16. The first side portion 12 houses a display and a keypad (not labeled). The second side portion 16 includes a planar surface 162 and four side surfaces 164. The planar surface 162 is recessed to form a battery accommodating cavity 166. Two opposite side surfaces 164 each define two L-shape latching slots 168.

The battery cover 20 includes a bottom wall 22 and four sidewalls 26, thereby cooperatively surrounding a space for receiving the second side portion 16 of the housing 10. An inside portion of the bottom wall 22 defines a rectangular groove 226 for receiving the cushion 30. Two of the sidewalls 26 each form two spaced blocks 268, for receipt in the latching slots 168.

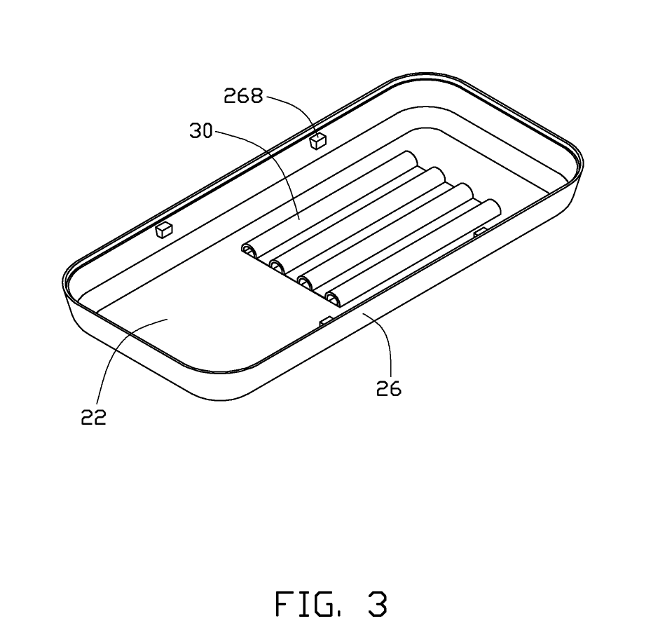

Referring to FIG. 3, the cushion 30 is substantially a waved pad of elastic material such as rubber or sponge. In this exemplary embodiment, the cushion 30 is polyurethane. The cushion 30 includes a plurality of connecting portions 301 and a plurality of buffering portions 302. The connecting portions 301 and buffering portions 302 are parallel and alternately arranged. In this embodiment, the connecting portions 301 are substantially planar pad-shaped, and the buffering portions 302 are substantially semi-cylindrical. When the battery cover 20 is attached to the housing 10, the buffering portion 302 of the cushion 30 contacts the battery 40.

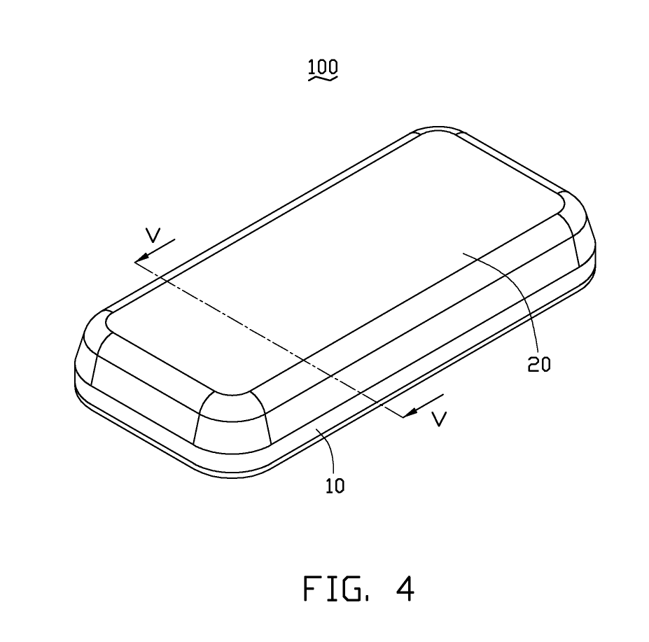

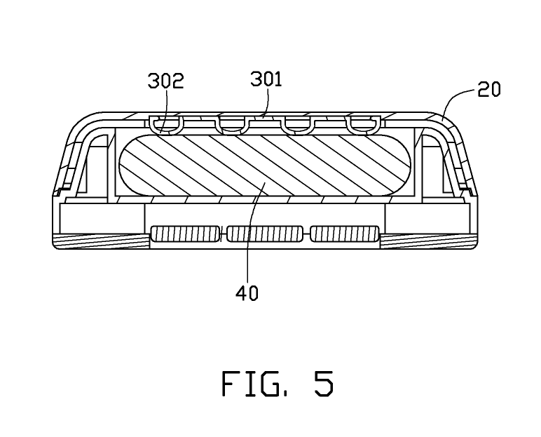

Referring to FIG. 4, during assembly, the cushion 30 is fixed in the receiving groove 226 of the battery cover 20, such as by hot melting or adhesive. Then, the blocks 268 of the battery cover 20 are aligned with the latching slots 168 of the housing 10, and the battery cover 20 is pressed downward to engage the battery cover 20 with the housing 10. Referring to FIG. 5, the cushion 30 is sandwiched between the battery cover 20 and the battery 40. The buffering portions 302 contact the battery 40. When the buffering portions 302 deform, the cushion structure prevents the downward pressing force from being directly applied to the battery 40.

When the battery cover 20 is assembled in the housing 10, the cushion 30 may decrease the effects of impact force reduce the abrasion therebetween.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device comprising:
a housing;
a battery cover, the battery cover removably latching the housing,
a cushion disposed between the housing and the battery cover for elastically abutting a battery.

2. The portable electronic device as claimed in claim 1, wherein the cushion is substantially a waved pad.

3. The portable electronic device as claimed in claim 1, wherein the cushion is made of elastic material.

4. The portable electronic device as claimed in claim 1, wherein the cushion includes a plurality of connecting portions and a plurality of buffering portions, the connecting portions and the buffering portions are parallel and alternately arranged.

5. The portable electronic device as claimed in claim 4, wherein the connecting portions are substantially planar pad-shaped, and the buffering portions are substantially semi-cylindrical.

6. The portable electronic device as claimed in claim 1, wherein the housing defines at least one latching slot, the battery cover forms a block, and the block is removably received in the at least one latching slot.

7. A portable electronic device with a battery comprising:
a housing;
a battery cover, the battery cover removably latching the housing, an inside of the battery cover defining a groove;
a cushion being receiving in the groove, the cushion elastically abutting the battery.

8. The portable electronic device as claimed in claim 7, wherein the cushion includes a plurality of connecting portions and a plurality of buffering portions, the connecting portions and the buffering portions are parallel and alternately arranged.

9. The portable electronic device as claimed in claim 8, wherein the connecting portions are substantially planar pad-shaped, and the buffering portions are substantially semi-cylindrical.

10. The portable electronic device as claimed in claim 7, wherein the housing defines at least one latching slot, the battery cover forms a block, and the block is removably received in the at least one latching slot.
